(19) United States
(12) Patent Application Publication
(10) Pub. No.: US 2019/0233693 A1
(43) Pub. Date: Aug. 1, 2019

(54) SHAPED ABRASIVE PARTICLES WITH SHARP TIPS

(71) Applicant: 3M INNOVATIVE PROPERTIES COMPANY, St. Paul, MN (US)

(72) Inventors: Dwight D. Erickson, Woodbury, MN (US); Ian R. Owen, Baldwin, WI (US); Shawn C. Dodds, St. Paul, MN (US); Matthew S. Stay, Minneapolis, MN (US); Scott R. Culler, Burnsville, MN (US); John T. Boden, White Bear Lake, MN (US); William C. Quade, Stillwater, MN (US); Joseph D. Solem, Cottage Grove, MN (US); Negus B. Adefris, St. Paul, MN (US); Chainika Jangu, Woodbury, MN (US); Thomas J. Anderson, Cottage Grove, MN (US); Gregory S. Mueller, Eden Prairie, MN (US); William Blake Kolb, Stillwater, MN (US)

(21) Appl. No.: 16/320,220

(22) PCT Filed: Jul. 31, 2017
(86) PCT No.: PCT/US2017/044566

§ 371 Date: Jan. 24, 2019

Related U.S. Application Data
(60) Provisional application No. 62/369,367, filed on Aug. 1, 2016.

(51) Int. Cl. C09K 3/14

(52) U.S. Cl. CPC C09K 3/1409; C09K 3/1436

(57) ABSTRACT

Various embodiments disclosed relate to shaped abrasive particles having sharp tips, methods of making the shaped abrasive particles, methods of abrading a substrate with the shaped abrasive particles, and coated abrasive articles including the shaped abrasive particles. The shaped abrasive particle includes a ceramic, has a polygonal cross-sectional shape along a longitudinal axis of the shaped abrasive particle, and at least one tip of the shaped abrasive particle has a radius of curvature of less than or equal to about 19.2 microns.

### BACKGROUND

Abrasive particles and abrasive articles made from the abrasive particles are useful for abrading, finishing, or grinding a wide variety of materials and surfaces in the manufacturing of goods. There continues to be a need for improving the cost, performance, or life of the abrasive particle or the abrasive article, such as in abrasive methods with low pressure or down force which do not break the abrasive particles during the use of the particle or article.

### SUMMARY OF THE INVENTION

In various embodiments, the present invention provides a shaped abrasive particle including a ceramic. The shaped abrasive particle includes a polygonal cross-sectional shape along a longitudinal axis of the shaped abrasive particle. At least one tip of the shaped abrasive particle has a radius of curvature of less than or equal to about 19.2 microns.

In various embodiments, the present invention provides a method of abrading. The method includes abrading a substrate with a plurality of the shaped abrasive particles.

In various embodiments, the present invention provides a method of making the shaped abrasive particle. The method includes placing a starting material composition in a mold. The method includes curing the starting material composition in the mold, to form the shaped abrasive particle.

In various embodiments, the present invention provides a coated abrasive article. The coated abrasive article includes a backing. The coated abrasive article includes a make coat on a first major surface of the backing. The coated abrasive article also includes an abrasive layer on the make coat including a plurality of the shaped abrasive particles.

In various embodiments, the present invention provides a method of abrading. The method includes abrading a substrate with the coated abrasive article that includes the plurality of the shaped abrasive particles.

In various embodiments, the present invention provides a coated abrasive article. The coated abrasive article includes a backing, and a make coat on a first major surface of the backing. The coated abrasive article also includes an abrasive layer on the make coat including a plurality of shaped abrasive particles. The plurality of shaped abrasive particles are about 0.5 wt % to about 100 wt % of the abrasive layer. The shaped abrasive particles independently include about 100 wt % alpha alumina and have a polygonal cross-sectional shape along a longitudinal axis of the shaped abrasive particle. A tip on the largest face of each of the shaped abrasive particles independently has a radius of curvature of less than or equal to about 5 microns. The radius of curvature is the radius of the smallest circle that, when viewed in a direction orthogonal to the largest face of the shaped abrasive particle: passes through a point on each of the two sides of the largest face of the shaped abrasive particle that come together to form the tip at the start of a curve of the tip wherein each of the two sides transition from straight to curved, and encompasses the entire tip.

Various embodiments of the present invention have various advantages over other shaped particles, methods of making shaped particles, articles including shaped particles, and methods of abrading using shaped particles, at least some of which are unexpected. For example, in some embodiments, the shaped abrasive particle of the present invention can provide greater abrasion performance than other abrasive particles. In some embodiments, the shaped abrasive particle of the present invention can provide a high removal rate when used to abrade a substrate, as compared to other abrasive particles used under corresponding conditions.

In some embodiments, the method of making the shaped abrasive particles of the present invention can provide shaped abrasive particles having sharper tips, and more consistently sharp tips, than other methods of making shaped abrasive particles.

### BRIEF DESCRIPTION OF THE FIGURES

The drawings illustrate generally, by way of example, but not by way of limitation, various embodiments discussed in the present document.

FIG. 1 illustrates a top view of a shaped abrasive particle having a triangular shape, in accordance with various embodiments.

FIG. 2 illustrates a side view of the shaped abrasive particle of FIG. 1, in accordance with various embodiments.

FIG. 3 illustrates a measurement of the radius of curvature of a tip, in accordance with various embodiments.

FIG. 4 illustrates a coated abrasive article made from the shaped abrasive particles of FIG. 1, in accordance with various embodiments

FIGS. 5A-B illustrate photomicrographs of shaped abrasive particles, in accordance with various embodiments.

FIG. 6 illustrates the total cut of several abrasive particles, in accordance with various embodiments.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

### Shaped Abrasive Particle.

In various embodiments, the present invention provides a shaped abrasive particle. The shaped abrasive particle can include a ceramic. The shaped abrasive particle can include a polygonal cross-sectional shape along a longitudinal axis of the shaped abrasive particle. At least one tip of the shaped abrasive particle can have a radius of curvature of less than or equal to about 19.2 microns.

The cross-sectional shape of the shaped abrasive particle can be any suitable polygonal shape, such as is a triangle, a rectangle, a trapezoid, or a pentagon.

The shaped abrasive particle can include a volumetric aspect ratio of greater than about 1.15, wherein the volumetric aspect ratio is a ratio of the maximum cross-sectional area passing through the centroid of the shaped abrasive particle divided by the minimum cross-sectional area passing through the centroid of the shaped abrasive particle. In various embodiments of the invention, the volumetric aspect ratio for the shaped abrasive particles can be greater than about 1.15, or greater than about 1.50, or greater than about 2.0, or between about 1.15 to about 10.0, or between about 1.20 to about 5.0, or between about 1.30 to about 3.0.

The shaped abrasive particle can include a first face and a second face connected to each other by a sidewall, the first face and the second face separated by a thickness, t. The shaped abrasive particle can include a draft angle α between the second face and the sidewall. The draft angle α can be other than 90 degrees, such as about 95 degrees to about 130 degrees.

In various embodiments, the perimeter of the first face and the second face can be any suitable polygonal shape, such as a triangle, a rectangle, a trapezoid, or a pentagon. A perimeter of the first face and the second face can be substantially triangular.

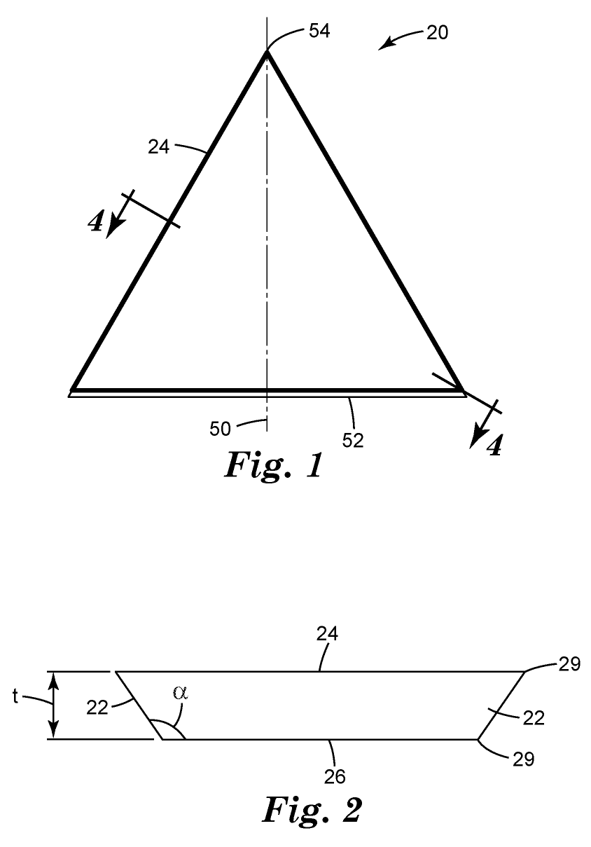

Referring to FIGS. 1 and 2, an embodiment of a shaped abrasive particle 20 is illustrated. In some embodiments, the shaped abrasive particle includes a sidewall 22 having a draft angle α other than 90 degrees and referred to hereafter as a sloping sidewall. FIG. 1 is a top view of the open face of the particle 20, and FIG. 2 is a side view taken along line 4-4 from FIG. 1. The material from which the shaped abrasive particle 20 is made includes alpha alumina.

In general, the shaped abrasive particles 20 include thin bodies having a first face 24, and a second face 26 and having a thickness t. In some embodiments, the thickness t ranges between about 25 micrometers to about 500 micrometers. The first face 24 and the second face 26 are connected to each other by at least one sidewall 22, which may be a sloping sidewall. In some embodiments, more than one sloping sidewall 22 can be present and the slope or angle for each sloping sidewall 22 may be the same or different. In some embodiments, the first face 24 is substantially planar, the second face 26 is substantially planar, or both faces are substantially planar. Alternatively, the faces could be concave or convex. Additionally, an opening or aperture through the faces can be present.

In one embodiment, the first face 24 and the second face 26 are substantially parallel to each other. In other embodiments, the first face 24 and second face 26 can be nonparallel such that one face is sloped with respect to the other face and imaginary lines tangent to each face would intersect at a point. The sidewall 22 of the shaped abrasive particle 20 can vary and it generally forms the perimeter 29 of the first face 24 and the second face 26. In one embodiment, the perimeter 29 of the first face 24 and the second face 26 is selected to be a geometric shape, and the first face 24 and the second face 26 are selected to have the same geometric shape; although, they differ in size with one face being larger than the other face. In one embodiment, the perimeter 29 of first face 24 and the perimeter 29 of the second face 26 is a triangular shape, as illustrated.

Referring back to FIG. 1, the shaped abrasive particle 20 includes a longitudinal axis 50 extending from a base 52 to the grinding tip 54. In a coated abrasive article, the sidewall 22 of the base 52 is typically attached to the backing 42 in the coated abrasive article 40 by the make coat 44.

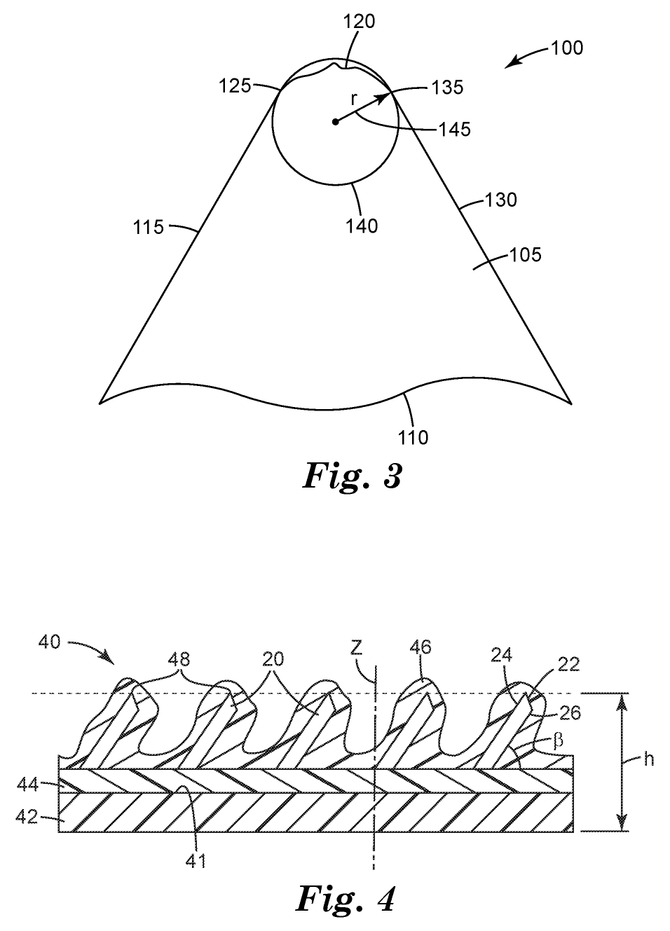

The radius of curvature of the at least one tip is the radius of the smallest circle that, when viewed in a direction orthogonal to a face of the shaped abrasive particle including the tip, passes through a point on each of the two sides of the face of the shaped abrasive particle that come together to form the tip at the start of a curve of the tip where each of the two sides transition from straight to curved. FIG. 3 illustrates method of determining the radius of curvature of a tip of a shaped abrasive particle. FIG. 3 illustrates a section of a shaped abrasive particle 100. Only a section of shaped abrasive particle 100 is shown in FIG. 3, with the remainder of the particle represented by the wavy line 110. The shaped abrasive particle includes a face 105 having two sides 115 and 130 of the face 105 that come together to form the tip 120. A circle 140 is drawn that passes through point 125, wherein side 115 transitions from straight to curved to form the tip 120. Circle 140 also passes through point 135, wherein side 130 transitions from straight to curved to form the tip 120. The circle is drawn such that it is the smallest circle possible, in the place of the face 105, that passes through both points 125 and 135, and also completely encompasses the tip 120 such that no portion of the tip crosses the boundary of the circle 140. The radius (r), 145, of the circle 140 represents the radius of curvature of the tip 120.

The maximum radius of curvature can be any suitable value, such that the abrasive particle is effective for abrasive applications. For example, the radius of curvature can be less than or equal to about 19.2 microns, less than or equal to about 15 microns, less than or equal to about 5 microns, less than or equal to about 3 microns, or less than, equal to, or greater than about 19 microns, 18, 17, 16, 15, 14, 13, 14, 13, 12, 11, 10, 9, 8, 7, 6, 5, 4.5, 4, 3.5, 3, 2.5, 2, 1.5, 1, 0.5, 0.4, 0.3, 0.2, 0.1, 0.05, or about 0.01 micron or less.

In various embodiments, the maximum radius of curvature can be defined in terms an average radius of curvature of all the tips of the shaped abrasive particle, or an average radius of curvature of all the tips of a plurality of shaped abrasive particles. For example, the tips of the plurality of the shaped abrasive particle have an average radius of curvature of less than or equal to about a maximum, such as about 19.2 microns.

The at least one tip having a maximum radius of curvature can be on an open face of the particle, for example, a face of the particle having the largest surface area, or a face of the particle at the open end of a mold used to form the particle (e.g., the largest end, which forms the largest face). For example, the at least one tip having a maximum radius of curvature can be a tip on the largest face of the shaped abrasive particle, wherein the radius of curvature is the radius of the smallest circle that, when viewed in a direction orthogonal to the largest face of the shaped abrasive particle: passes through a point on each of the two sides of the largest face of the shaped abrasive particle that come together to form the tip at the start of a curve of the tip wherein each of the two sides transition from straight to curved, and encompasses the entire tip.

In various embodiments, the maximum radius of curvature can be defined in terms an average radius of curvature of all the open face tips the shaped abrasive particle, or an average radius of curvature of all the open face tips of a plurality of shaped abrasive particles. For example, the open face tips of the plurality of the shaped abrasive particle have an average radius of curvature of less than or equal to about a maximum, such as about 19.2 microns. The shaped abrasive particle can include a first face and a second face connected to each other by a sidewall, the first and second face being substantially parallel to one another, the first face having a larger surface area than the second face. The first face can have the largest surface area of any face of the shaped abrasive particle (e.g., the open face). The shaped abrasive particle can include a tip on the first face having a maximum radius of curvature, or all the tips on the first face can have a maximum radius of curvature, such as about 19.2 microns.

The ceramic can be any suitable ceramic that is suitable for abrasive applications. The ceramic can be an inorganic, non-metallic, oxide, nitride, or carbide material, such as of aluminum, titanium, zinc, boron, tungsten, silicon, or a combination thereof. The ceramic can be kaolinite, alumina, zirconia, silicon carbide, silicon nitride, tungsten carbide, boron nitride, boron oxide, titanium carbide, or a combination thereof. The ceramic can be alumina, such as alpha-alumina. The ceramic can be any suitable proportion of the shaped abrasive particle, such as about 50 wt % to about 100 wt % of the shaped abrasive article, about 100 wt %, or about 50 wt % or less, or less than, equal to, or greater than about 55 wt %, 60, 65, 70, 75, 80, 85, 90, 91, 92, 93, 94, 95, 96, 97, 98, 99, 99.9, 99.99 wt %, or about 99.999 wt % or more of the shaped abrasive article.

The shaped abrasive particle can have any suitable particle size (e.g., the largest dimension of the particle). The shaped abrasive particle can have a particle size of about 4 microns (e.g., about P6000) to about 1800 microns (e.g., about P12), or about 25 microns (e.g., about P600) to about 70 microns (e.g., about P220), or about 4 microns or less, or less than, equal to, or greater than about 5 microns, 6, 7, 8, 9, 10, 12, 14, 16, 18, 20, 25, 30, 35, 40, 45, 50, 55, 60, 65, 70, 75, 80, 85, 90, 95, 100, 110, 120, 130, 140, 150, 160, 180, 200, 225, 250, 275, 300, 350, 400, 450, 500, 600, 700, 800, 900, 1,000, 1,200, 1,400, 1,600 microns, or about 1,800 microns or more.

### Method of Making the Shaped Abrasive Particle.

In various embodiments, the present invention provides a method of making the shaped abrasive particle. The method can be any suitable method that forms an embodiment of the shaped abrasive article having a maximum radius of curvature described herein. The method can include placing a starting material composition in a mold. The method can include curing the starting material composition in the mold, to form the shaped abrasive particle. As used herein “curing” refers to any chemical or physical transformation that leads to a hardening of a material. Curing can include heating the starting material composition until it transforms into the ceramic.

Placing the starting material composition in the mold can be performed in any suitable way. In some embodiments, a scraper or draw bar can be used to force the starting material composition fully into the cavities of the mold.

The starting material composition can be any suitable starting material composition that can be cured to form the shaped abrasive particle, e.g., the ceramic. The starting material composition can include a dispersion of materials in a volatile component that can be heated to form the ceramic. The volatile component can be water. The dispersed materials can be precursors of the ceramic. For example, for an alumina ceramic, the starting material composition can be an aqueous sol or gel of aluminum oxide monohydrate (e.g., behmite).

The method can further include placing a release coat in the mold prior to the placing of the starting material composition in the mold. The release coat can allow the formed shaped abrasive particles to release from the mold with little or no adhesion to the mold. Adhesion to the mold can make it difficult to remove the shaped abrasive particles from the mold, and can cause fracturing of the particles as they are removed from the mold. In other embodiments, the mold can be substantially free of release agent during the placing and curing of the starting material composition in the mold.

The release coat can include any suitable material that facilitates the release of the shaped abrasive particles from the mold. For example, the release coat can include a release agent such as peanut oil, mineral oil, fish oil, silicones, polytetrafluoroethylene, zinc sterate, graphite, or a combination thereof. In some embodiments, applying the release coat can include applying about 0.1 wt % to about 5 wt % of the release agent, such as peanut oil, in a liquid, such as water or an alcohol, to the mold.

Accumulations of the release coated or the release agent in the corners of the mold can cause dull tips. Although use of no release agent can generate extremely sharp tips, the resultant cured particles often break forming abrasive particle shards. By controlling the amount of release agent in the corners of the production tooling the sharpness of the tips can be controlled. The release coating and the release agent can have a concentration on the surface sufficient to avoid, reduce, or minimize the release coating forming non-uniform regions in corners of the mold during the placing and curing of the starting material composition in the mold, which can cause dull tips. The release agent can be substantially uniformly distributed on the mold, such as in a substantially uniform release coating; in other embodiments, the release agent can be distributed in a non-uniform manner. In some embodiments, the concentration of the release agent on the mold can be about 0.001 mg/in² to about 5.0 mg/in², or about 0.01 mg/in² to about 3.0 mg/in², or about 0.001 mg/in² or less, or less than, equal to, or greater than about 0.005 mg/in², 0.01, 0.05, 0.1, 0.5, 1, 1.5, 2, 2.5, or about 3.0 mg/in² or more. The release coating can have a thickness of about 0.001 micron to about 1 mm, or about 0.050 microns to about 5 microns, or about 1 micron to about 10 microns, or about 0.001 microns or less, or less than, equal to, or greater than about 0.005 microns, 0.01, 0.05, 0.1, 0.5, 1, 2, 3, 4, 5, 6, 7, 8, 9, 10, 15, 20, 25, 50, 100, 200, 500, about 750 microns, or about 1 mm. The release coating can be applied in any suitable way, such as via brush, spray, ink-jet, gravure, slot-die or knife, notch-bar, tensioned-web, squeeze roll, roll coating methods, 5-roll coating, 3-roll coating, meyer rod coating, curtain coating, slide coating, or a combination thereof.

### Coated Abrasive Article.

In various embodiments, the present invention provides a coated abrasive article. The coated abrasive article can include a backing, with a make coat on a first major surface of the backing. The coated abrasive article can include an abrasive layer on the make coat including a plurality of the shaped abrasive particles having a maximum radius of curvature described herein.

Any suitable proportion of the abrasive layer, or of the total amount of abrasive particles in the abrasive layer, can be the shaped abrasive particles, such as about 0.001 wt % to about 100 wt %, about 0.5 wt % to about 60 wt %, about 8 wt % to about 15 wt %, or about 0.001 wt % or less, or less than, equal to, or greater than about 0.01 wt %, 0.1, 0.5, 1, 2, 3, 4, 5, 6, 7, 8, 9, 10, 11, 12, 13, 14, 15, 16, 17, 18, 19, 20, 22, 24, 26, 28, 30, 35, 40, 45, 50, 55, 60, 65, 70, 75, 80, 85, 90, 91, 92, 93, 94, 95, 96, 97, 98, 99, 99.9, 99.99, or about 99.999 wt % or more.

The abrasive layer can further include abrasive particles that are non-shaped (e.g., crushed abrasive filler particles, such as crushed alumina, having an essentially random shape). The abrasive particles that are not shaped can have any suitable particle size (e.g., the largest dimension of the particle), such as about 4 microns (e.g., about P6000) to about 1800 microns (e.g., about P12), or about 25 microns (e.g., about P600) to about 70 microns (e.g., about P220), or about 4 microns or less, or less than, equal to, or greater than about 5 microns, 6, 7, 8, 9, 10, 12, 14, 16, 18, 20, 25, 30, 35, 40, 45, 50, 55, 60, 65, 70, 75, 80, 85, 90, 95, 100, 110, 120, 130, 140, 150, 160, 180, 200, 225, 250, 275, 300, 350, 400, 450, 500, 600, 700, 800, 900, 1,000, 1,200, 1,400, 1,600 microns, or about 1,800 microns or more. The abrasive particles that are not shaped in the abrasive layer including the shaped abrasive particles can form the remainder of the abrasive layer or any suitable proportion of the abrasive layer, such as about 0.001 wt % to about 99.999 wt % of the abrasive layer, about 40 wt % to about 99.5 wt %, about 85 wt % to about 92 wt % of the abrasive layer.

The shaped abrasive particles can be adhered to the make coat via a sidewall of the shaped abrasive particles. The shaped abrasive particles adhered to the make coat by the sidewall can have an orientation angle β of about 50 degrees to about 85 degrees. The coated abrasive article can further include a size coat on the abrasive layer.

Referring to FIG. 4, the shaped abrasive particles 20 can be used to make a coated abrasive article 40 having a first major surface 41 of a backing 42 covered by an abrasive layer including a plurality of shaped abrasive particles 20. The coated abrasive article 40 includes a make coat 44 over the first major surface 41 and a plurality of shaped abrasive particles 20 attached to the make coat 44, such as via the sidewall 22. A size coat 46 can be applied to further attach or adhere the shaped abrasive particles 20 to the backing 42. An optional super size coating as known to those of skill in the art may also be applied.

Referring to FIG. 4, a coated abrasive article 40 includes a backing 42 having a first layer of binder, hereinafter referred to as the make coat 44, applied over a first major surface 41 of backing 42. Attached or partially embedded in the make coat 44 are a plurality of shaped abrasive particles 20 forming an abrasive layer. Over the shaped abrasive particles 20 is a second layer of binder, hereinafter referred to as the size coat 46. The purpose of make coat 44 is to secure shaped abrasive particles 20 to the backing 42 and the purpose of size coat 46 is to reinforce shaped abrasive particles 20. An optional super size coating, as known to those of skill in the art, may also be applied. The majority of the shaped abrasive particles 20 are oriented such that the tip 48 (grinding tip 54 FIG. 1) or vertex points away from the backing 42 and the shaped abrasive particles are resting on the sidewall 22. If a sloping sidewall is used, the shaped abrasive particles 20 are generally tipped or leaning as shown.

To further optimize the leaning orientation, the shaped abrasive particles with a sloping sidewall are applied in the backing in an open coat abrasive layer. As used herein, a closed coat abrasive layer is the maximum weight of abrasive particles or a blend of abrasive particles that can be applied to a make coat of an abrasive article in a single pass through the maker. An open coat is an amount of abrasive particles or a blend of abrasive particles, weighing less than the maximum weight in grams that can be applied, that is applied to a make coat of a coated abrasive article. An open coat abrasive layer will result in less than 100% coverage of the make coat with abrasive particles thereby leaving open areas and a visible resin layer between the particles. In various embodiments of the invention, the percent open area in the abrasive layer can be about 10% to about 90%, or about 30% to about 80%, or about 40% to about 70%.

In some embodiments, if too many of the shaped abrasive particles with a sloping sidewall are applied to the backing, insufficient spaces between the particles will be present to allow from them to lean or tip prior to curing the make and size coats. In various embodiments of the invention, greater than 50, 60, 70, 80, or 90 wt % of the shaped abrasive particles in the coated abrasive article having an open coat abrasive layer are tipped or leaning having an orientation angle β (FIG. 4) of less than 90 degrees.

Without wishing to be bound by theory, it is believed that an orientation angle β less than 90 degrees results in enhanced cutting performance of the shaped abrasive particles with a sloping sidewall. Surprisingly, this result tends to occur regardless of the shaped abrasive particles' rotational orientation about the Z axis within the coated abrasive article. While FIG. 4 is idealized to show all the particles aligned in the same direction, an actual coated abrasive disc would have the particles randomly distributed and rotated. Since the abrasive disc is rotating and the shaped abrasive particles are randomly distributed, some shaped abrasive particles will be driven into the workpiece at an orientation angle β of less than 90 degrees with the workpiece initially striking the second face 26 while a neighboring shaped abrasive particle could be rotated exactly 180 degrees with the workpiece striking backside of the shaped abrasive particle and the first face 24. With a random distribution of the particles and the rotation of the disc, less than half of the shaped abrasive particles could have the workpiece initially striking the second face 26 instead of the first face 24. However, for an abrasive belt having a defined direction of rotation and a defined point of contact with the workpiece, it may be possible to align the shaped abrasive particles with a sloping sidewall on the belt to ensure that each shaped abrasive particle runs at an orientation angle β of less than 90 degrees and that the workpiece is driven into the second face 26 first as idealized in FIG. 4. In various embodiments of the invention, the orientation angle for at least a majority of the shaped abrasive particles with a sloping sidewall in an abrasive layer of a coated abrasive article can be between about 50 degrees to about 85 degrees, or between about 55 degrees to about 85 degrees, or between about 60 degrees to about 85 degrees, or between about 65 degrees to about 85 degrees, or between about 70 degrees to about 85 degrees, or between about 75 degrees to about 85 degrees, or between about 80 degrees to about 85 degrees.

The make coat 44 and size coat 46 include a resinous adhesive. The resinous adhesive of the make coat 44 can be the same as or different from that of the size coat 46. Examples of resinous adhesives that are suitable for these coats include phenolic resins, epoxy resins, urea-formaldehyde resins, acrylate resins, aminoplast resins, melamine resins, acrylated epoxy resins, urethane resins, and combinations thereof. In addition to the resinous adhesive, the make coat 44 or size coat 46, or both coats, may further include additives that are known in the art, such as, for example, fillers, grinding aids, wetting agents, surfactants, dyes, pigments, coupling agents, adhesion promoters, and combinations thereof. Examples of fillers include calcium carbonate, silica, talc, clay, calcium metasilicate, dolomite, aluminum sulfate and combinations thereof.

A grinding aid can be applied to the coated abrasive article. As used herein, a grinding aid is particulate material, the addition of which has a significant effect on the chemical and physical processes of abrading, thereby resulting in improved performance. Grinding aids encompass a wide variety of different materials and can be inorganic or organic. Examples of chemical groups of grinding aids include waxes, organic halide compounds, halide salts, and metals and their alloys. The organic halide compounds will typically break down during abrading and release a halogen acid or a gaseous halide compound. Examples of such materials include chlorinated waxes, such as tetrachloronaphthalene, pentachloronaphthalene; and polyvinyl chloride. Examples of halide salts include sodium chloride, potassium cryolite, sodium cryolite, ammonium cryolite, potassium tetrafluoroborate, sodium tetrafluoroborate, silicon fluorides, potassium chloride, magnesium chloride. Examples of metals include tin, lead, bismuth, cobalt, antimony, cadmium, iron, and titanium. Other grinding aids include sulfur, organic sulfur compounds, graphite, and metallic sulfides. It is also within the scope of this invention to use a combination of different grinding aids; in some instances, this may produce a synergistic effect. In one embodiment, the grinding aid was cryolite or potassium tetrafluoroborate. The amount of such additives can be adjusted to give desired properties. It is also within the scope of this invention to utilize a supersize coating. The supersize coating typically contains a binder and a grinding aid. The binders can be formed from such materials as phenolic resins, acrylate resins, epoxy resins, urea-formaldehyde resins, melamine resins, urethane resins, and combinations thereof.

It is also within the scope of this invention that the shaped abrasive particles 20 can be utilized in a bonded abrasive article, a nonwoven abrasive article, or abrasive brushes. A bonded abrasive can include a plurality of the shaped abrasive particles 20 bonded together by means of a binder to form a shaped mass. The binder for a bonded abrasive can be metallic, organic, or vitreous. A nonwoven abrasive includes a plurality of the shaped abrasive particles 20 bonded to a fibrous nonwoven web by means of an organic binder.

### Method of Making the Coated Abrasive Article.

In various embodiments, the present invention provides a method of making the coated abrasive article. The method can be any suitable method that generates an embodiment of the coated abrasive article described herein including the shaped abrasive particles having a maximum radius of curvature. The method can include applying a plurality of the shaped abrasive particles to a make coat on a first major surface of a backing.

### Method of Abrading.

In various embodiments, the present invention provide a method of abrading. The method includes abrading a substrate with a plurality of the shaped abrasive particles described herein having a maximum radius of curvature. The method can be any suitable method that includes abrading a substrate with an embodiment of the shaped abrasive particles described herein. In some embodiments, the method can be a method of abrading the substrate with the coated abrasive article including a plurality of the shaped abrasive particles described herein having a maximum radius of curvature.

In some embodiments, during the abrading (e.g., during the abrasion cycle from beginning to end), the majority of shaped abrasive particles do not break. In such applications, the sharpness of the abrasive particles can surprisingly have a dramatic influence on the abrasive performance of the of the abrasive particles, such as on the amount of substrate removed using a given amount of pressure over a given amount of time. The substrate can be any suitable substrate, such as metal (e.g., steel), paint, body filler, primer, wood, or a combination thereof.

### EXAMPLES

Various embodiments of the present invention can be better understood by reference to the following Examples which are offered by way of illustration. The present invention is not limited to the Examples given herein.

Unit abbreviations used in the Examples: ° C.: degrees Centigrade; cm: centimeter; g/m²: grams per square meter; mm: millimeter; rpm: revolutions per minute.

Materials. Unless otherwise noted, all parts, percentages, ratios, etc. in the Examples and the rest of the specification are by weight. The materials used in the Examples are shown in Table 1.

TABLE 1
Materials.

| ABBRE- | |
|---|---|
| VIATION | DESCRIPTION |
| ACR | Trimethylolpropane triacrylate obtained under the trade |
| | designation “TMPTA” from Allnex Inc., Brussels, Belgium. |
| ALO | Aluminum oxide conforming the FEPA (Federation of the |
| | European Producers of Abrasives) standard for P320, obtained |
| | under the trade designation “BFRPL” from Imerys Fused |
| | Minerals, Niagara Falls, New York. |
| AMOX | Di-t-amyl oxalate |
| CHDM | 1,4-cyclohexane dimethanol obtained from Eastman Chemical |
| | Company, Kingsport, Tennessee. |
| EP1 | Bisphenol-A epichlorohydrin based epoxy resin having an |
| | epoxy equivalent weight of 525-550 grams/eq. and an average |
| | epoxy functionality of 2, available as “EPON 1001F” from |
| | Momentive Specialty Chemicals, Inc., Columbus, Ohio |
| EP2 | Bisphenol-A epoxy resin having an epoxy equivalent weight |
| | of 185-192 g/eq. and an average epoxy functionality of 2, |
| | available as “EPON 828” from Momentive Specialty |
| | Chemicals, Inc. |
| EP3 | Biphenol-A epoxy resin having an epoxy equivalent weight |
| | of 210-220 g/eq, obtained under the tradename of EPONEX |
| | 1510 from Momentive Specialty Chemicals, Inc. |
| Minex | Anhydrous sodium potassium alumino silicate obtained |
| | from Unimin Corporation, New Canaan, Connecticut. |
| PC1 | Mixture of 4-thiophenylphenyl diphenyl sulfonium |
| | hexafluoroantimonate, and bis[4-(diphenylsulfonio)phe- |
| | nyl]sulfide bis(hexafluoroantimonate) in propylene carbonate, |
| | obtained under the trade designation “CPI 6976” from Aceto |
| | Corporation, Port Washington, New York. |
| PC2 | 2,2-dimethoxy-2-phenylacetophenone, obtained under trade |
| | designation “IRGACURE 651” from BASF, Wyandotte, |
| | Michigan. |
| PC3 | η⁶-(xylene)-η⁵-(cyclopentadienyl) iron hexafluoroantimonate |
| PC4 | Ethyl (2,4,6-trimethylbenzoyl) phenylphosphinate, obtained |
| | under the trade designation “IRGACURE TPO-L” from BASF |
| | Corporation, Wyandotte, Michigan. |
| PEP | A high molecular weight, hydroxyl-terminated, saturated, |
| | linear, semicrystalline, copolyester, with a weight average |
| | molecular weight of 35000 grams/mol, obtained under the |
| | trade designation “DYNAPOL S 1227” from Evonik |
| | Industries, Parsippany, New Jersey. |
| PPC | Propylene carbonate, obtained under the trade designation |
| | “JEFFSOL PROPYLENE CARBONATE” from Huntsman |
| | Corporation, Salt Lake City, Utah. |
| W985 | Solution of acidic polyester with sodium o-phenylphenate, |
| | obtained under the trade designation “BYK-W 985” from |
| | Altana AG, Wesel, Germany. |
| IRG | 2-hydroxy-2-methyl-1-phenyl-1-propan-1-one obtained under |
| | trade designation “IRGACURE 1173” from BASF |
| | Corporation. |
| PP | Purple pigment commercially available under the trade |
| | designation “9S93” from Penn Color, Doylestown, |
| | Pennsylvania. |

Radius of curvature general measurement method. The average radius of curvature of the shaped abrasive particles was determined as the average radius of curvature of the open face tips of the particles. The radius of curvature was determined as the radius of the smallest circle that, when viewed in a direction orthogonal to the open face of the shaped abrasive particle including the open face tip, passes through a point on each of the two sides of the open face of the shaped abrasive particle that come together to form the tip at the start of a curve of the tip where each of the two sides transition from straight to curved. The average of 12 radii from four particles is taken.

### Example 1. Formation of Shaped Abrasive Particles

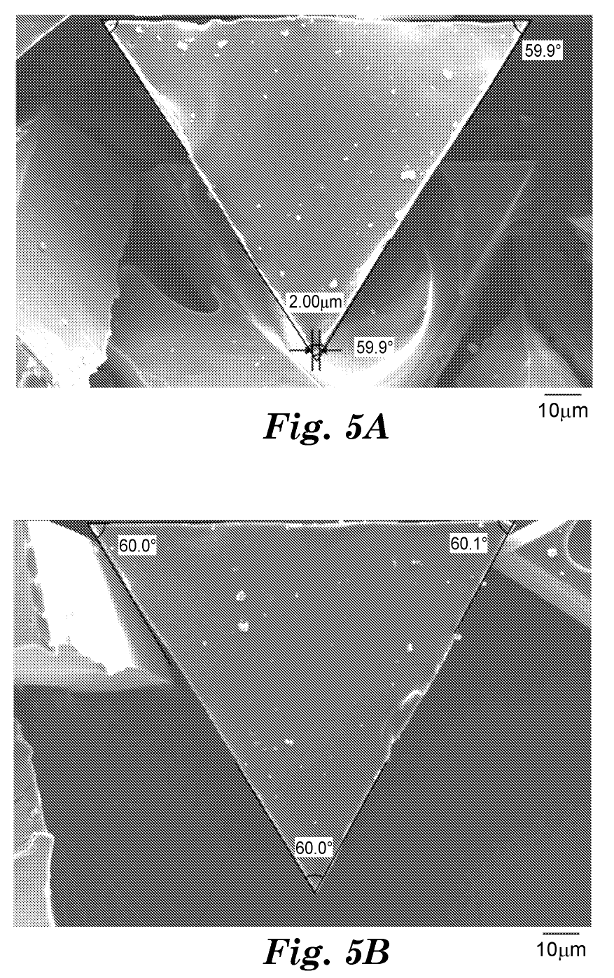

A sample of boehmite sol-gel was made using the following recipe: aluminum oxide monohydrate powder (1600 parts) having the trade designation “DISPERAL” was dispersed by high shear mixing a solution containing water (2400 parts) and 70% aqueous nitric acid (72 parts) for 11 minutes. The resulting sol-gel was aged for at least 1 hour before coating. The sol-gel was forced into production tooling having triangular shaped mold cavities of 2.67 mils (69 microns) depth and 8 mils (203 microns) on each side. The draft angle α between the sidewall and bottom of the mold was 98 degrees. The sol-gel was forced into the cavities with a putty knife so that the openings of the production tooling were completely filled. A mold release agent, 0.2% peanut oil in methanol was used to coat the production tooling using a brush to fill the open cavities in the production tooling. The excess methanol was allowed to evaporate in a hood at room temperature. The sol-gel coated production tooling was allowed to air dry at room temperature for at least 10 minutes, giving a concentration of release agent (after evaporation of the methanol) of 0.08 mg/in², and an average thickness of the coating (prior to evaporation of the methanol) of 138 microns. The precursor shaped abrasive particles were removed from the production tooling by passing it over an ultrasonic horn. The precursor shaped abrasive particles were calcined at approximately 650° C. and then saturated with a mixed nitrate solution of the following concentration (reported as oxides): 1.8% each of MgO, Y₂O₃, Nd₂O₃ and La₂O₃. The excess nitrate solution was removed and the saturated precursor shaped abrasive particles with openings were allowed to dry after which the particles were again calcined at 650° C. and sintered at approximately 1400° C. Both the calcining and sintering was performed using rotary tube kilns. The fired shaped abrasive particles (with photomicrographs thereof shown in FIGS. 5A-B) were about 0.12 millimeter (side length)×0.04 millimeter thick. The average radius of curvature of the resultant shaped abrasive particles was 2.0 micron, as measured according to the radius of curvature general measurement method described in the Examples.

### Example 2. Preparation of Make Resin and Size Resin

A make resin was prepared, according to the composition listed in Table 2. AMOX, EP1, EP2, CHDM and PEP were directly metered to a twin screw extruder running at 300 rpm and compounded at the rate of 26-40 kilograms per hour in temperature zones of 30° C., 105° C., 110° C., 100° C., 65° C., and 60° C. This compounded resin was then fed to a pin mixer running at 1750 rpm, and ACR, PC2, PC3, PC4, and PPC were directly metered into the pin mixer and mixed for approximately 10 minutes.

TABLE 2
Make resin composition.

| | Weight |
|---|---|
| Component | Percentage |
| EP1 | 24.0 |
| EP2 | 32.0 |
| PEP | 28.0 |
| ACR | 10.0 |
| CHDM | 2.8 |
| PC2 | 0.5 |
| PC3 | 0.7 |
| PC4 | 0.3 |
| PPC | 1.1 |
| AMOX | 0.6 |

The size resin premix was prepared by mixing 70% EP3 and 30% ACR. To 55.06% of this premix, 0.59% W985, 39.95% Minex, 3% PC1, 1% IRG, and 0.40% PP. The formulation was stirred for 30 minutes at 24° C. until homogeneous.

### Example 3A. Preparation of Coated Abrasive Article

Paper backing was used having a basis weight of 135-142 g/m² (obtained from Neenah Paper Inc., Neenah, Wis.) was coated with 10 g/m² of the make resin prepared as the procedure above. The coating was exposed to ultraviolet curing equipment (obtained from Fusion UV Systems, Gaithersburg, Md.) with one set of D bulbs and one set of V bulbs both operating at 600 Watts per inch (236 Watts per centimeter). Abrasive particle blend was prepared by mixing 10% shaped abrasive particles prepared as the procedure above and 90% ALO. The abrasive particle blends were then coated onto the make coat at a nominal coating weight of 37 g/m² by electrostatic coating. The web is then exposed to infrared heaters at a nominal web temperature setting of 100° C., for about 7 seconds. The size resin was then roll coated onto the make layer and abrasive particles at a nominal dry coating weight of 37 g/m². The resultant article was exposed to ultraviolet curing equipment (obtained from Fusion UV Systems, Gaithersburg, Md.) with one set of H bulbs, and two sets of D-bulbs, all three operating at 600 Watts per inch (236 Watts per centimeter). It was then processed through infrared ovens having a target exit web temperature of 125° C. The calcium stearate supersize was applied on the top with a coating weight of 10 g/m² using roll-coat technique, then dried at temperature setting of 60-90° C. zones. After drying, the strip of coated abrasive was converted into 6-inch (15.24-cm) diameter discs as is knows in the art. The resultant coated abrasive articles were then maintained at 24° C. and 40-60 percent relative humidity until tested.

### Example 3B. Comparative. Preparation of Coated Abrasive Article

The procedure generally described in Example 1 was repeated, with the exception that shaped abrasive particles used were prepared according the specification of method described in U.S. Pat. No. 8,142,531. The shaped abrasive particles were 0.12 millimeter (side length)×0.04 millimeter thick. The average radius of curvature of the resultant shaped abrasive particles was 4.45 micron, as measured according to the method described in the specification.

### Example 3C. Comparative. Preparation of Coated Abrasive Article

Coated abrasive disc obtained under trade designation “PURPLE CLEAN SANDING HOOKIT DISC 334U” 6 inch, P320 grit from 3M Company, Saint Paul, Minn.

### Example 4. Characterization of Sharpness of Shaped Abrasive Particles

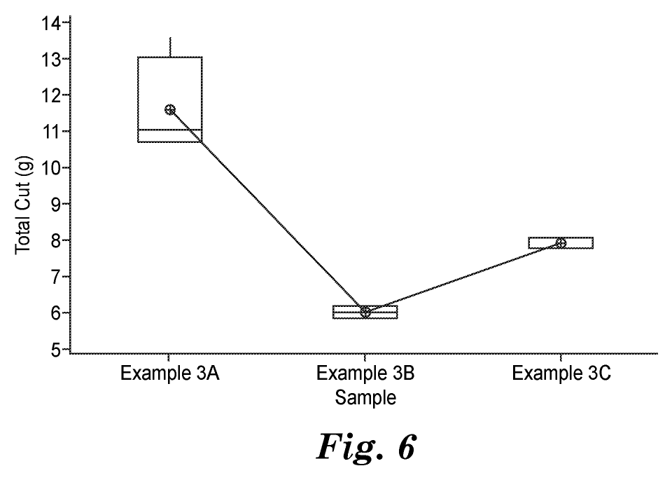

A 6 inch (15.24 cm) diameter abrasive disc to be tested were mounted on a dual-action sander tool, obtained under trade designation “RANDOM ORBITAL SANDER ELITE SERIES” in self-generated vacuum 3/16 in orbit from 3M Company. The tool was disposed over an X-Y table having an Automotive test panel (obtained as “59597” from ACT, Hillsdale, Mich.) with 18 inches (45.7 cm)×24 inches (61.0 cm)×0.036 inches (0.09 cm) dimensions, secured to the X-Y table. The rotary tool was activated to rotate at 5250 rpm under no load. The abrasive article was then urged at an angle of 2.5 degrees against the panel at a load of 13 pounds (5.90 kilograms) down force. The tool was then set to traverse in the Y direction along the length of the panel at the rate of 3.50 inches/minute (8.9 cm/minute) and in X direction at the rate of 3.50 inches/minute (8.9 cm/minute) along the width of the panel. Seven such passes along the length of the panel were completed in each cycle for a total of 3 cycles. The mass of the panel was measured before and after each cycle to determine the mass loss from the clear coating layer of OEM panel in grams after each cycle. Total cut was determined as the cumulative mass loss at the end of the test. The surface finish was measured as average surface roughness in micro-inches (1 micro-inch is 25.4 nanometers) using a contact profilometer such as a Mahr Perthometer M2 from Mahr Federal Inc., Providence, R.I. The test results are shown in Table 3 and FIG. 6.

TABLE 3
Performance measurement.

| | Test | Total Cut | Average Surface |
|---|---|---|---|
| | Replicates | (Grams) | Roughness |
| Example 3A | Test 1 | 13.60 | 376 μin, |
| | Test 2 | 11.29 | 9.55 microns |
| | Test 3 | 10.69 | |
| | Test 4 | 10.75 | |
| Comparative | Test 1 | 5.96 | 315 μin, |
| Example 3B | Test 2 | 6.12 | 8.00 microns |
| | Test 3 | 5.80 | |
| Comparative | Test 1 | 7.76 | 286 μin, |
| Example 3C | Test 2 | 8.04 | 7.26 microns |
| | Test 3 | 7.78 | |

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Additional Embodiments

The following exemplary embodiments are provided, the numbering of which is not to be construed as designating levels of importance:

Embodiment 1 provides a shaped abrasive particle comprising:

a ceramic; and

a polygonal cross-sectional shape along a longitudinal axis of the shaped abrasive particle;

wherein at least one tip of the shaped abrasive particle has a radius of curvature of less than or equal to about 19.2 microns.

Embodiment 2 provides the shaped abrasive particle of Embodiment 1, wherein the radius of curvature of the at least one tip is the radius of the smallest circle that, when viewed in a direction orthogonal to a face of the shaped abrasive particle comprising the tip:

passes through a point on each of the two sides of the face of the shaped abrasive particle that come together to form the tip at the start of a curve of the tip wherein each of the two sides transition from straight to curved, and

encompasses the entire tip.

Embodiment 3 provides the shaped abrasive particle of any one of Embodiments 1-2, wherein the at least one tip is a tip on the largest face of the shaped abrasive particle, wherein the radius of curvature is the radius of the smallest circle that, when viewed in a direction orthogonal to the largest face of the shaped abrasive particle:

passes through a point on each of the two sides of the largest face of the shaped abrasive particle that come together to form the tip at the start of a curve of the tip wherein each of the two sides transition from straight to curved, and

encompasses the entire tip.

Embodiment 4 provides a plurality of the shaped abrasive particles of any one of Embodiments 1-3, wherein the tips of the plurality of the shaped abrasive particles have an average radius of curvature of less than or equal to about 19.2 microns.

Embodiment 5 provides the shaped abrasive particle of any one of Embodiments 1-4, comprising

a first face and a second face connected to each other by a sidewall, the first and second face being substantially parallel to one another, the first face having a larger surface area than the second face;

wherein the at least one tip having a radius of curvature of less than or equal to about 19.2 microns is a tip on the first face of the shaped abrasive particle.

Embodiment 6 provides a plurality of the shaped abrasive particles of Embodiment 5, wherein the tips of the first face of the plurality of the shaped abrasive particles have an average radius of curvature of less than or equal to about 19.2 microns.

Embodiment 7 provides the shaped abrasive particle of any one of Embodiments 1-6, wherein the ceramic is about 50 wt % to about 100 wt % of the shaped abrasive article.

Embodiment 8 provides the shaped abrasive particle of any one of Embodiments 1-7, wherein the ceramic is about 100 wt % of the shaped abrasive article.

Embodiment 9 provides the shaped abrasive particle of any one of Embodiments 1-8, wherein the ceramic is kaolinite, alumina, zirconia, silicon carbide, silicon nitride, tungsten carbide, boron nitride, boron oxide, titanium carbide, or a combination thereof.

Embodiment 10 provides the shaped abrasive particle of any one of Embodiments 1-9, wherein the ceramic is alumina.

Embodiment 11 provides the shaped abrasive particle of any one of Embodiments 1-10, wherein the ceramic is alpha-alumina.

Embodiment 12 provides the shaped abrasive particle of any one of Embodiments 1-11, wherein the at least one tip is a tip on an open face of the shaped abrasive particle.

Embodiment 13 provides the shaped abrasive particle of any one of Embodiments 1-12, wherein the shaped abrasive particle comprises at least one tip having a radius of curvature of less than or equal to about 15 microns.

Embodiment 14 provides the shaped abrasive particle of any one of Embodiments 1-13, wherein the shaped abrasive particle comprises at least one tip having a radius of curvature of less than or equal to about 5 microns.

Embodiment 15 provides the shaped abrasive particle of any one of Embodiments 1-14, wherein the shaped abrasive particle comprises at least one tip having a radius of curvature of less than or equal to about 3 microns.

Embodiment 16 provides the shaped abrasive particle of any one of Embodiments 1-15, wherein the shaped abrasive particle has a particle size of about 4 microns to about 1800 microns.

Embodiment 17 provides the shaped abrasive particle of any one of Embodiments 1-16, wherein the shaped abrasive particle has a particle size of about 25 microns to about 70 microns.

Embodiment 18 provides the shaped abrasive particle of any one of Embodiments 1-17, wherein the cross-sectional shape is a triangle, a rectangle, a trapezoid, or a pentagon.

Embodiment 19 provides the shaped abrasive particle of any one of Embodiments 1-18, comprising a volumetric aspect ratio of greater than about 1.15, wherein the volumetric aspect ratio is a ratio of the maximum cross-sectional area passing through the centroid of the shaped abrasive particle divided by the minimum cross-sectional area passing through the centroid of the shaped abrasive particle.

Embodiment 20 provides the shaped abrasive particle of any one of Embodiments 1-19, comprising

a first face and a second face connected to each other by a sidewall, the first face and the second face separated by a thickness, t; and

a draft angle α between the second face and the sidewall.

Embodiment 21 provides the shaped abrasive particle of Embodiment 20, wherein a perimeter of the first face and the second face is substantially triangular.

Embodiment 22 provides the shaped abrasive particle of any one of Embodiments 20-21, wherein the draft angle α is about 95 degrees to about 130 degrees.

Embodiment 23 provides a method of abrading, comprising:

abrading a substrate with a plurality of the shaped abrasive particles of any one of Embodiments 1-22.

Embodiment 24 provides the method of Embodiment 23, wherein during the abrading the majority of shaped abrasive particles do not break.

Embodiment 25 provides the method of any one of Embodiments 23-24, wherein the substrate comprises metal, paint, body filler, primer, wood, or a combination thereof.

Embodiment 26 provides a method of making the shaped abrasive particle of any one of Embodiments 1-25, the method comprising:

placing a starting material composition in a mold; and

curing the starting material composition in the mold, to form the shaped abrasive particle of any one of Embodiments 1-25.

Embodiment 27 provides the method of Embodiment 26, wherein the starting material composition is a sol.

Embodiment 28 provides the method of any one of Embodiments 26-27, wherein during the placing and curing of the starting material composition the mold is substantially free of a release agent.

Embodiment 29 provides the method of any one of Embodiments 26-28, further comprising placing a release coat in the mold prior to the placing of the starting material composition in the mold.

Embodiment 30 provides the method of Embodiment 29, wherein the release coat is applied to the mold in a substantially uniform coating.

Embodiment 31 provides the method of any one of Embodiments 29-30, wherein the coating has a thickness sufficient to avoid or minimize the release coating forming non-uniform regions in corners of the mold during the placing and curing of the starting material composition in the mold.

Embodiment 32 provides the method of any one of Embodiments 29-31, wherein the coating has a thickness of about 0.001 micron to about 1 mm.

Embodiment 33 provides a coated abrasive article comprising:

a backing;

a make coat on a first major surface of the backing; and

an abrasive layer on the make coat comprising a plurality of the shaped abrasive particles of any one of Embodiments 1-22.

Embodiment 34 provides the coated abrasive article of Embodiment 33, wherein the shaped abrasive particles are about 0.001 wt % to about 100 wt % of the abrasive layer.

Embodiment 35 provides the coated abrasive article of any one of Embodiments 33-34, wherein the shaped abrasive particles are about 0.5 wt % to about 60 wt % of the abrasive layer.

Embodiment 36 provides the coated abrasive article of any one of Embodiments 33-35, wherein the shaped abrasive particles are about 8 wt % to about 15 wt % of the abrasive layer.

Embodiment 37 provides the coated abrasive article of any one of Embodiments 33-36, wherein the abrasive layer further comprises abrasive particles that are not shaped.

Embodiment 38 provides the coated abrasive particle of Embodiment 37, wherein the abrasive particles that are not shaped are about 0.001 wt % to about 99.999 wt % of the abrasive layer.

Embodiment 39 provides the coated abrasive particle of any one of Embodiments 37-38, wherein the abrasive particles that are not shaped are about 40 wt % to about 99.5 wt % of the abrasive layer.

Embodiment 40 provides the coated abrasive particle of any one of Embodiments 37-39, wherein the abrasive particles that are not shaped are about 85 wt % to about 92 wt % of the abrasive layer.

Embodiment 41 provides the coated abrasive article of any one of Embodiments 33-40, wherein a majority of the shaped abrasive particles are adhered to the make coat by a sidewall of the shaped abrasive particle.

Embodiment 42 provides the coated abrasive article of Embodiment 41, wherein the shaped abrasive particles adhered to the make coat by the sidewall have an orientation angle β of about 50 degrees to about 85 degrees.

Embodiment 43 provides the coated abrasive article of any one of Embodiments 33-42, further comprising a size coat on the abrasive layer.

Embodiment 44 provides a method of abrading, comprising:

abrading a substrate with the coated abrasive article of any one of Embodiments 33-43.

Embodiment 45 provides the method of Embodiment 44, wherein during the abrading the majority of shaped abrasive particles do not break.

Embodiment 46 provides the method of any one of Embodiments 44-45, wherein the substrate comprises metal, paint, body filler, primer, wood, or a combination thereof.

Embodiment 47 provides a method of making the coated abrasive article of any one of Embodiments 33-43, the method comprising:

applying a plurality of the shaped abrasive particles to a make coat on a first major surface of a backing, to form the coated abrasive article of any one of Embodiments 33-43.

Embodiment 48 provides a coated abrasive article comprising:

a backing;

a make coat on a first major surface of the backing; and

an abrasive layer on the make coat comprising a plurality of shaped abrasive particles, wherein the plurality of shaped abrasive particles are about 0.5 wt % to about 100 wt % of the abrasive layer, each of the shaped abrasive particles independently comprising:
about 100 wt % alpha alumina; and
a polygonal cross-sectional shape along a longitudinal axis of the shaped abrasive particle;
wherein a tip on the largest face of the shaped abrasive particle has a radius of curvature of less than or equal to about 5 microns, wherein the radius of curvature is the radius of the smallest circle that, when viewed in a direction orthogonal to the largest face of the shaped abrasive particle:
   passes through a point on each of the two sides of the largest face of the shaped abrasive particle that come together to form the tip at the start of a curve of the tip wherein each of the two sides transition from straight to curved, and
   encompasses the entire tip.

Embodiment 49 provides the shaped abrasive particle, coated abrasive article, or method of any one or any combination of Embodiments 1-48 optionally configured such that all elements or options recited are available to use or select from.

1. A shaped abrasive particle comprising:
a ceramic; and
a polygonal cross-sectional shape along a longitudinal axis of the shaped abrasive particle;
wherein at least one tip of the shaped abrasive particle has a radius of curvature of less than or equal to about 19.2 microns.

2. The shaped abrasive particle of claim 1, wherein the radius of curvature of the at least one tip is the radius of the smallest circle that, when viewed in a direction orthogonal to a face of the shaped abrasive particle comprising the tip:
passes through a point on each of the two sides of the face of the shaped abrasive particle that come together to form the tip at the start of a curve of the tip wherein each of the two sides transition from straight to curved, and
encompasses the entire tip.

3. The shaped abrasive particle of claim 1, wherein the at least one tip is a tip on the largest face of the shaped abrasive particle, wherein the radius of curvature is the radius of the smallest circle that, when viewed in a direction orthogonal to the largest face of the shaped abrasive particle:
passes through a point on each of the two sides of the largest face of the shaped abrasive particle that come together to form the tip at the start of a curve of the tip wherein each of the two sides transition from straight to curved, and
encompasses the entire tip.

4. A plurality of the shaped abrasive particles of claim 1, wherein the tips of the plurality of the shaped abrasive particles have an average radius of curvature of less than or equal to about 19.2 microns.

5. The shaped abrasive particle of claim 1, comprising
a first face and a second face connected to each other by a sidewall, the first and second face being substantially parallel to one another, the first face having a larger surface area than the second face;
wherein the at least one tip having a radius of curvature of less than or equal to about 19.2 microns is a tip on the first face of the shaped abrasive particle.

6. The shaped abrasive particle of claim 1, wherein the at least one tip is a tip on an open face of the shaped abrasive particle.

7. The shaped abrasive particle of claim 1, wherein the shaped abrasive particle comprises at least one tip having a radius of curvature of less than or equal to about 15 microns.

8. The shaped abrasive particle of claim 1, wherein the shaped abrasive particle has a particle size of about 4 microns to about 1800 microns.

9. The shaped abrasive particle of claim 1, comprising a volumetric aspect ratio of greater than about 1.15, wherein the volumetric aspect ratio is a ratio of the maximum cross-sectional area passing through the centroid of the shaped abrasive particle divided by the minimum cross-sectional area passing through the centroid of the shaped abrasive particle.

10. A method of abrading, comprising:
abrading a substrate with a plurality of the shaped abrasive particles of claim 1.

11. The method of claim 10, wherein during the abrading the majority of shaped abrasive particles do not break.

12. A coated abrasive article comprising:
a backing;
a make coat on a first major surface of the backing; and
an abrasive layer on the make coat comprising a plurality of the shaped abrasive particles of claim 1.

13. The coated abrasive article of claim 12, wherein the abrasive layer further comprises abrasive particles that are not shaped.

14. The coated abrasive article of claim 12, wherein a majority of the shaped abrasive particles are adhered to the make coat by a sidewall of the shaped abrasive particle.

15. The coated abrasive article of claim 14, wherein the shaped abrasive particles adhered to the make coat by the sidewall have an orientation angle β of about 50 degrees to about 85 degrees.

16. A method of abrading, comprising:
abrading a substrate with the coated abrasive article of claim 12.

17. The method of claim 16, wherein during the abrading the majority of shaped abrasive particles do not break.

18. A coated abrasive article comprising:
a backing;
a make coat on a first major surface of the backing; and
an abrasive layer on the make coat comprising a plurality of shaped abrasive particles, wherein the plurality of shaped abrasive particles are about 0.5 wt % to about 100 wt % of the abrasive layer, each of the shaped abrasive particles independently comprising:
about 100 wt % alpha alumina; and
a polygonal cross-sectional shape along a longitudinal axis of the shaped abrasive particle;
wherein a tip on the largest face of the shaped abrasive particle has a radius of curvature of less than or equal to about 5 microns, wherein the radius of curvature is the radius of the smallest circle that, when viewed in a direction orthogonal to the largest face of the shaped abrasive particle:
passes through a point on each of the two sides of the largest face of the shaped abrasive particle that come together to form the tip at the start of a curve of the tip wherein each of the two sides transition from straight to curved, and
encompasses the entire tip.
